(19) United States
(12) Patent Application Publication
(10) Pub. No.: US 2006/0207101 A1
(43) Pub. Date: Sep. 21, 2006

(54) Utility cutter

(75) Inventor: Robert Scarla, Scottsdale, AZ (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 11/335,154

(22) Filed: Jan. 19, 2006

Related U.S. Application Data
(60) Provisional application No. 60/593,510, filed on Jan. 20, 2005.

(51) Int. Cl. B25F 3/00

(52) U.S. Cl. 30/145

(57) ABSTRACT

A utility cutter comprising a first handle member having a handle end and a working end distal to the handle end and a second member having a handle end and a working end distal to the handle end wherein the first member is pivotally coupled to the second member. A cutting implement including a blade is coupled to the second member proximate to the working end of the second member, and a cutting surface is coupled to the first member proximate to the working end of the first member.

### CROSS-REFERENCE TO RELATED PATENT APPLICATIONS

This application is a application claiming the benefit under 35 USC 119(e) U.S. Application No. 60/593,510, filed Jan. 20, 2005, which is incorporated herein by reference in its entirety.

### BACKGROUND

The present invention relates generally to the field of handheld cutters. In particular, the present invention relates to handheld utility cutters using trapezoidal blades.

Handheld utility cutters are used to cut a variety of materials including rubber, plastic, rope, and other materials. Because of the materials and items commonly cut with handheld utility cutters the blades of such cutters are subject to wear and may require replacement.

Users of handheld utility cutters often use other cutting instruments including sliding blade utility knives, folding utility knives and other tools incorporating blades. Some of these tools utilize razor blades or other common blades. Common blades used in cutting tools include trapezoidal utility blades. These blades are common to a variety of cutting tools including folding utility knives and sliding blade utility knives. Various styles of these blades include safety blades with bobbed corners, high-strength blades made with specialized materials. Some of these blades include one or more notches along a top edge, e.g., opposite a cutting edge, to facilitate coupling the blade to the tool with which it is used.

Accordingly, it would be advantageous to provide a handheld utility cutter that is capable of operating with one or more of these common blades. In particular, it would be advantageous to provide a handheld utility cutter that is capable of operating with a trapezoidal utility blade. Such a cutter will reduce the need of users to purchase and maintain a variety of different blades.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY

One aspect relates to a utility cutter comprising a first handle member having a handle end and a working end distal to the handle end and a second handle member having a handle end and a working end distal to the handle end wherein the first handle member is pivotally coupled to the second handle member. A cutting implement including a blade removeably coupled to the second handle member proximate to the working end of the second member is provided. A cutting surface is coupled to the first handle member proximate to the working end of the first handle member.

Another aspect relates to a utility cutter comprising a first handle, and a second handle pivotally coupled to the first handle. The utility cutter includes a cutting implement comprising a blade coupled to the second handle and an anvil removeably coupled to the first handle. The anvil includes a cutting surface.

Another aspect relates to a utility cutter comprising a first handle and a second handle pivotally coupled to the first handle. The first handle includes a first member and a second member having substantially the same profile as the first member. A trapezoidal utility blade having a cutting edge is removeably coupled to the second handle. A retaining member is coupled to the second handle and configured to retain the trapezoidal utility blade. The utility cutter further includes an anvil removeably coupled to the first handle and at least partially disposed between the first member and the second member. The anvil includes a cutting surface configured to contact the cutting edge of the trapezoidal utility blade when the utility cutter is in a closed position and extending in a plane that is substantially perpendicular to the trapezoidal utility blade. The utility cutter is biased into an open position by a biasing mechanism. The utility cutter also includes a safety for locking the utility cutter in a closed position

### BRIEF DESCRIPTION OF THE DRAWINGS

FIG. 1 is an elevation view of a utility cutter.

FIG. 2 is an elevation view of a utility cutter.

FIG. 3 is an exploded perspective view of a utility cuter.

### DETAILED DESCRIPTION

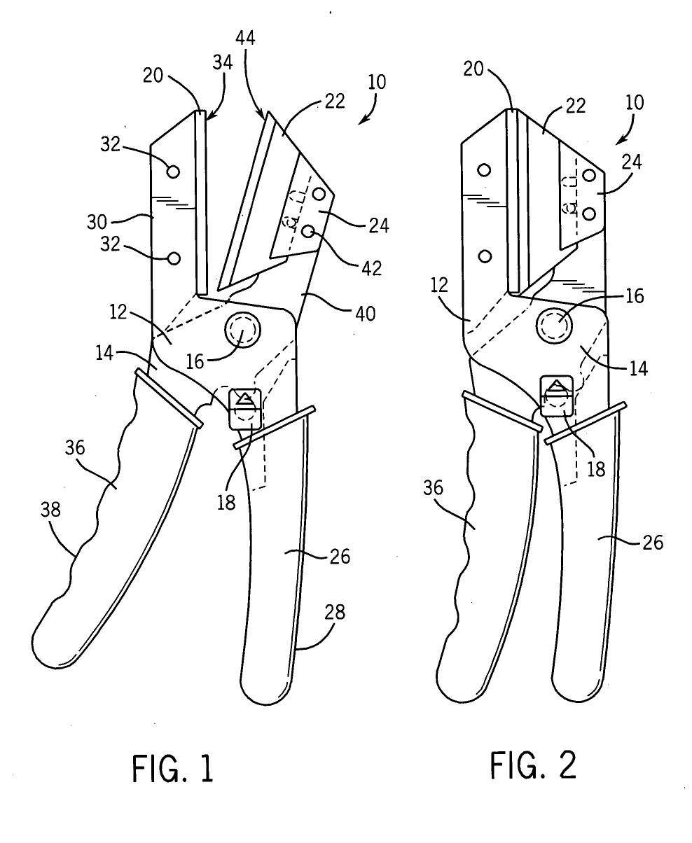

Referring to FIGS. 1 and 2, cutter 10 includes a first handle member 12, a second handle member 14, a fastener 16, a safety 18, an anvil 20, a blade 22, and a retaining member 24. First handle member 12 includes a handle portion 26, a handle cover 28, a working portion 30, fasteners 32. Fasteners 32 couple anvil 20 to working portion 30 of first handle member 12 such that cutting surface 34 of anvil 20 is oriented towards blade 22. Fasteners 32 may be screws, rivets, bolts or other suitable fastener.

Second handle member 14 includes a handle portion 36, a handle cover 38, working portion 40, and fasteners 42. Fasteners 42 couple retaining member 24 to working portion 40 of second handle member 14 such that blade 22 is retained between retaining member 24 and first handle member 12.

Blade 22 includes a cutting edge 44 that is oriented towards cutting surface 34. Blade 22 is shown as a trapezoidal utility blade. An exemplary blade may have a cutting edge that is about 2.559 inches long, a height of about 0.780 inches (measured from the cutting edge to an opposing edge), and sides angled at about 50°. In other embodiments, a trapezoidal blade may have sides angled from about 40° and 60°. Alternatively, safety trapezoidal blades having bobbed corners may be used. The blade may be made of carbon steel. Alternatively, stainless steel, coatings including powder coatings, anodized metals, or other materials may be used.

First member is pivotally coupled to second handle member 14 by fastener 16. First handle member 12 and second handle member 14 are coupled such that as handle portions 24 and 36 are moved towards each other, working portions 30 and 40 move towards each other to bring cutting edge 44 in proximity to cutting surface 34. Fastener 16 passes through portions of both first handle member 12 and second handle member 14. Alternatively, fastener 16 may comprise a plurality of sub-components. In some embodiments, alternative structures and/or methods for pivotally coupling first handle member 12 to second handle member 14.

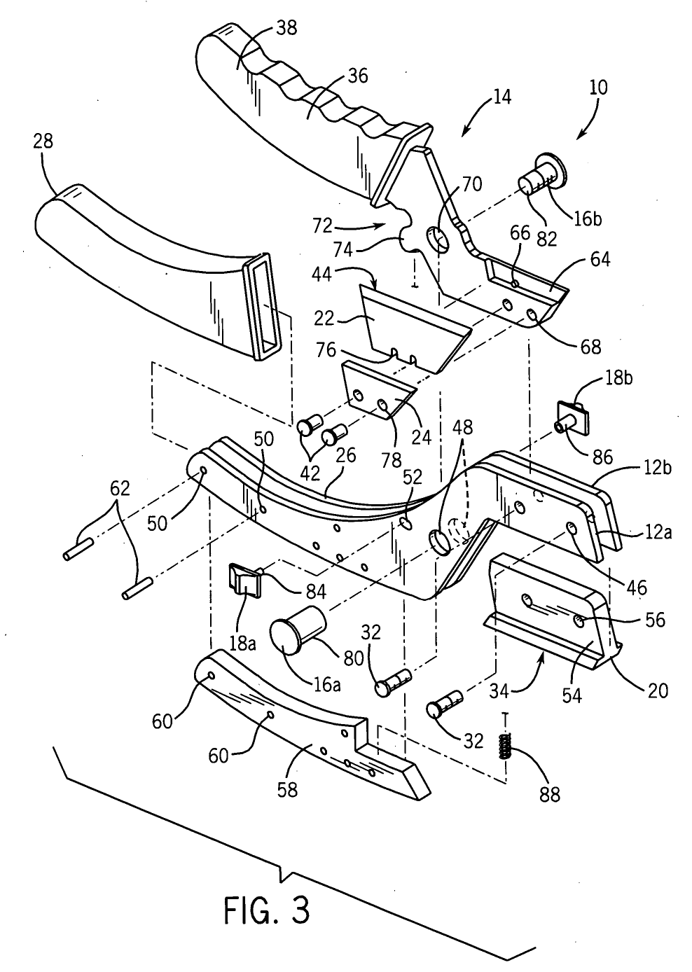

Referring to FIG. 3, utility cutter 10 includes first side member 12a and second side member 12b, and second handle member 14. Side members 12a and 12b may be identical components to reduce manufacturing costs. Side members 12a and 12b include apertures 46, aperture 48, apertures 50, and aperture 52. Anvil 20 includes an extension 54 having apertures 56. Extension 54 extends between side members 12a and 12b such that apertures 56 align with apertures 46. When assembled, fasteners 32 extend through apertures 46 in first side member 12a, through apertures 56, and to apertures 46 in second side member 12b. In some embodiments, one or more of apertures 46 or 56 may be tapped to threadably engage with fastener 32 which may be a screw, bolt, or other threaded fastener. In other embodiments, non-threaded fasteners may be used, such as rivets.

In the embodiment shown, spacer 58 includes apertures 60 and may be disposed between side members 12a and 12b such that apertures 60 align with apertures 50. Fasteners 62 may be used to couple side members 12a and 12b with spacer 58. When assembled, fasteners 62 extend through apertures 50 in first side member 12a, through apertures 60, and to apertures 50 in second side member 12b. In some embodiments fasteners 62 are pegs configures to fit flush with the edges of apertures 50. As with fasteners 32, any suitable fasteners may be used. Spacer 58 may be used to maintain a space between side members 12a and 12b such that side members 12a and 12b are substantially parallel. Handle cover 28 may be a polymeric cover configured to improve the grip for a user. Handle cover 28 may be slid over handle portion 26.

Second handle member 14 includes a recess 64, extension 66, apertures 68, aperture 60, recess 72, and extension 74. Blade 22 may include recess 76. Retaining member 24 includes apertures 78. Recess 64 if configured to receive a portion of blade 22.

Recess 64 is configured to receive a portion of blade 22 such that extension 66 may engage a recess 76 in blade 22. In some embodiments, a plurality of extensions 66 may be provided on second handle member 14 for engaging a plurality of recesses 76 in blade 22. When assembled, retaining member 24 may be positioned over a portion of blade 22 such that blade 22 is secured between second handle member 14 and retaining member 24. Fasteners 42 extend through apertures 78 in receiving member 24, and through apertures 68 in second handle member 14. Fasteners 42, retaining member 24, and second handle member 14 may be configured such that cutter 10 may be used with a variety of blades having different thicknesses. In some embodiments, blade 22 may have a thickness of about 0.020 to 0.050 inches. In one such embodiment, blade 22 may have a thickness of about 0.010 to 0.030 inches. In yet another of these embodiments, blade 22 may have a thickness of about 0.015 or 0.023 inches.

When assembled, second handle member 14 extends between side members 12a and 12b such that aperture 70 of second handle member 14 aligns with apertures 48 in side members 12a and 12b. Fastener 16 is configured to extend through apertures 48 and aperture 70 such that side members 12a and 12b and second handle member 14 are pivotally coupled. In the embodiment shown, fastener 16 comprises a two piece assembly including a first portion 16a and a second portion 16b. First portion 16a includes a stem portion 80, and second portion 16b includes a stem portion 82. One of stem portions 80 or 82 may be configured to receive the other of stem portions 80 or 82. In some of these embodiments, stem portions 80 and 82 may be configured to be threadably coupled to one another. Alternatively, portions 16a and 16b may be coupled by adhesive or other suitable method.

In the embodiment shown, safety 18 comprises a two piece assembly including a first portion 18a and a second portion 18b. First portion 18a includes a stem portion 84, and second portion 18b includes a stem portion 86. One of stem portions 84 or 86 may be configured to receive the other of stem portions 84 or 86. In some of these embodiments, stem portions 84 and 86 may be configured to be threadably coupled to one another. In other embodiments, portions 18a and 18b may be coupled by adhesive or other suitable method. In alternative embodiments, the safety may comprise a latch or other mechanism for locking the cutter in a closed position.

Stem portions 84 and 86 extend through apertures 52 in side members 12a and 12b and recess 72. Apertures 52 are generally elongated such that stems 84 and 86 may slide along aperture 52. When safety 18 is positioned a first end of aperture 52 proximate to handle portions 26 and 36, stem portions 84 and 86 are positioned outside of recess 72. When safety 18 is positioned a second end of aperture 52 distal to handle portions 26 and 36, stem portions 84 and 86 are positioned within recess 72 such that first handle member 12 and second handle member 14 are limited in movement in relation to one another, locking cutter 10 in a closed position.

In some embodiments, extension 74 may be configured to engage a first end of a spring 88 such as a coil spring. A second end of spring 88 may be coupled to spacer 58 or another component of first handle member 12 whereby cutter 10 is biased into an open position. In other embodiments, spring 88 may comprise a leaf spring or other biasing mechanism.

The exemplary embodiments described herein possess the advantageous features described in the Background of the Invention section because a user may easily use one of variety of standardized utility blades that the user may already employ in other devices. Further, the user will not be required to maintain a different type of replacement blade for the cutter. Further, the utility cutter provides a superior anvil style design for use with trapezoidal blades.

While the detailed drawings, specific examples, and particular formulations given describe preferred and exemplary embodiments, they serve the purpose as illustration only. The inventions disclosed are not limited to the specific forms shown. The configuration of the utility cutter may differ depending on chosen performance characteristics and physical characteristics of the components of the utility cutter. For example, the blade may take a variety of configurations depending on the needs of the user, and the method of coupling the various components may vary. Furthermore, other substitutions, modifications, changes, and omissions may be made in the design, operating conditions, and arrangement of the exemplary embodiments without departing from the scope of the invention as expressed in the appended claims.

What is claimed is:

1. A utility cutter comprising:
a first handle member having a handle end and a working end distal to the handle end;
a second handle member having a handle end and a working end distal to the handle end wherein the first handle member is pivotally coupled to the second handle member;
a cutting implement including a blade removeably coupled to the second handle member proximate to the working end of the second member; and
a cutting surface coupled to the first handle member proximate to the working end of the first handle member.

2. The utility cutter of claim 1, wherein the utility cutter has an open position and a closed position and the utility cutter is biased into the open position by a bias mechanism.

3. The utility cutter of claim 2, wherein bias mechanism is a spring.

4. The utility cutter of claim 1, further comprising an anvil including the cutting surface.

5. The utility cutter of claim 4, wherein the first handle member comprises a first side member and a second side member, the side members having substantially similar profiles and at least a portion of the anvil is disposed between the first and second side members.

6. The utility cutter of claim 1, further comprising a safety mechanism configured to lock the utility cutter in a closed position.

7. The utility cutter of claim 1, wherein the blade is a trapezoidal blade.

8. The utility cutter of claim 7, wherein the trapezoidal blade includes a cutting edge and a side edge that intersect at an angle of about 40° to about 60°.

9. A utility cutter comprising:
a first handle;
a second handle pivotally coupled to the first handle;
a cutting implement comprising a blade coupled to the second handle; and
an anvil removeably coupled to the first handle, the anvil including a cutting surface.

10. The utility cutter of claim 9, wherein one of the first handle or the second handle comprises two members of substantially the same profile and one of the cutting implement or an anvil including the cutting surface is at least partially disposed between the two members.

11. The utility cutter of claim 9, wherein the blade has a thickness between about 0.01 inches and 0.05 inches.

12. The utility cutter of claim 11, wherein the blade has a trapezoidal shape including a cutting edge and a side edge that intersect at an angle of about 50°.

13. The utility cutter of claim 9, wherein the utility cutter has an open position and a closed position and the utility cutter is biased into the open position by a bias mechanism.

14. The utility cutter of claim 13, wherein bias mechanism is a spring.

15. The utility cutter of claim 9, wherein the anvil is formed as a single unitary body with the second handle.

16. A utility cutter comprising:
a first handle;
a second handle pivotally coupled to the first handle the first handle including a first member and a second member having substantially the same profile as the first member;
a cutting implement comprising a trapezoidal utility blade having a cutting edge, wherein the cutting implement is removeably coupled to the second handle;
a retaining member coupled to the second handle and configured to retain the trapezoidal utility blade;
an anvil removeably coupled to the first handle and at least partially disposed between the first member and the second member;
a cutting surface on the anvil configured to contact the cutting edge of the trapezoidal utility blade when the utility cutter is in a closed position and extending in a plane that is substantially perpendicular to the trapezoidal utility blade;
a bias mechanism configured to bias the utility cutter in an open position; and
a safety for locking the utility cutter in a closed position.

17. The utility cutter of claim 16, wherein the trapezoidal utility blade has a thickness between about 0.01 inches and 0.05 inches

18. The utility cutter of claim 17, wherein the trapezoidal utility blade includes a side edge that intersects the cutting edge at an angle of about 40° to 60°.

19. The utility cutter of claim 16, wherein the anvil comprises a polymeric material.

20. The utility cutter of claim 16, the first handle includes a peg configured to mate with a recess in the trapezoidal utility blade.
